(19) United States
(12) Patent Application Publication
(10) Pub. No.: US 2021/0143418 A1
(43) Pub. Date: May 13, 2021

(54) CARBON ADDITIVES FOR DIRECT COATING OF SILICON-DOMINANT ANODES

(71) Applicant: ENEVATE CORPORATION, Irvine, CA (US)

(72) Inventors: David J. Lee, Irvine, CA (US); Giulia Canton, Irvine, CA (US); Fred Bonhomme, Lake Forest, CA (US); Monika Chhorng, Irvine, CA (US); Ian Browne, Orange, CA (US); Jill Renee Pestana, Long Beach, CA (US)

(21) Appl. No.: 16/681,571

(22) Filed: Nov. 12, 2019

(51) Int. Cl. H01M 4/38; H01M 4/62; H01M 4/04

(52) U.S. Cl. CPC H01M 4/386; H01M 4/0404; H01M 4/0471; H01M 4/625

(57) ABSTRACT

Systems and methods are provided for carbon additives for direct coating of silicon-dominant anodes. An example composition for use in directly coated anodes may include a silicon-dominated anode active material, a carbon-based binder, and a carbon-based additive, with the composition being configured for low-temperature pyrolysis. The low-temperature pyrolysis may be conducted at <850° C. An anode may be formed using a direct coating process of the composition on a current collector. The anode active material may yield silicon constituting between 90% and 95% of weight of the formed anode after pyrolysis. The carbon-based additive may yield carbon constituting between 2% and 6% of weight of the formed anode after pyrolysis. The carbon-based additive may include carbon particles with surface area >65 m²/g.

### TECHNICAL FIELD

Aspects of the present disclosure relate to energy generation and storage. More specifically, certain implementations of the present disclosure relate to methods and systems for a carbon additives for direct coating of silicon-dominant anodes.

### BACKGROUND

Various issues may exist with conventional battery technologies. In this regard, conventional systems and methods, if any existed, for implementing battery electrodes may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for carbon additives for direct coating of silicon-dominant anodes, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 is a diagram of a battery with silicon-dominant anode processed using direct coating, in accordance with an example embodiment of the disclosure.

FIG. 2 illustrates an example silicon-dominant anode, in accordance with an example embodiment of the disclosure.

FIG. 3 is a flow diagram of a process for direct coating electrodes, in accordance with an example embodiment of the disclosure.

FIG. 4A is a bar chart of impedance data for various anode slurry formulations, in accordance with an example embodiment of the disclosure.

FIG. 4B is a plot illustrating discharge capacity performance for various anode slurry formulations, in accordance with an example embodiment of the disclosure.

FIG. 5 is a plot illustrating discharge capacity performance for various anode slurry formulations with different combinations of additives, in accordance with an example embodiment of the disclosure.

FIG. 6 is a plot illustrating electrical resistance performance for various anode slurry formulations with different combinations of additives, in accordance with an example embodiment of the disclosure.

FIG. 7 is a plot illustrating discharge capacity performance for various anode slurry formulations using different percentages of additive ECP, in accordance with an example embodiment of the disclosure.

FIG. 8 is a plot illustrating discharge capacity performance for various anode slurry formulations using different percentages of additive Super-P, in accordance with an example embodiment of the disclosure.

FIG. 9 is a plot illustrating discharge capacity performance for various anode slurry formulations using different percentages of additive SLP, in accordance with an example embodiment of the disclosure.

FIG. 10 is a plot illustrating cycle life performance for various anode slurry formulations, in accordance with an example embodiment of the disclosure.

### DETAILED DESCRIPTION

FIG. 1 is a diagram of a battery with electrode processed with controlled furnace atmosphere, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 107B, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 107 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 107B. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (Super-P), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

Various methods and/or processed may be used in forming the various components of the battery. For example, electrodes may be formed by such processes as lamination, and direct coating. Each of these processes may have unique challenges and/or limitations. For example, in direct coating of silicon-dominated anodes, pyrolysis is done at lower temperature (e.g., <850° C.). This may adversely affect carbonization, which in turn may affect conductivity (and thus storage and other electrical characteristics) of the formed anodes. Accordingly, certain measures may be needed to ensure that sufficient carbonization occurs when the pyrolysis step is performed in direct coated anode processes. For example, special slurry formulations may be devised and used to optimize performance of anodes made using direct coating processes. This is described further with respect to FIGS. 4-9.

FIG. 2 illustrates an example silicon-dominant anode, in accordance with an example embodiment of the disclosure. Referring to FIG. 2, there is shown an anode 200, a current collector 201, an adhesive 203, and an active material 205. It should be noted, however, that the adhesive 203 may or may not be present depending on the type of anode fabrication process utilized, as the adhesive is not necessarily there in a direct coating process where the active material is formed directly on the current collector.

In an example scenario, the active material 205 comprises silicon particles in a binder material and a solvent, the active material 205 being pyrolyzed to turn the binder into a pyrolytic carbon that provides a structural framework around the silicon particles and also provides electrical conductivity. The active material may be coupled to the current collector 201 using the optional adhesive 203. The current collector 201 may comprise a metal film, such as copper, nickel, or titanium, for example, although other conductive foils may be utilized depending on desired tensile strength.

FIG. 2 also illustrates lithium particles impinging upon and lithiating the active material 205. Also, as illustrated in FIG. 2, the current collector 201 has a thickness t, which may vary based on the particular implementation. In this regard, in some implementations thicker foils may be used while in other implementations thinner foils are used. Example thicker foils may be greater than 6 μm, such as 10 μm or 20 μm for copper, for example, while thinner foils may be less than 6 μm thick in copper.

In an example scenario, when an adhesive is used, the adhesive 203 comprises a polymer such as polyimide (PI) or polyamide-imide (PAI) that provides adhesive strength of the active material film 205 to the current collector 201 while still providing electrical contact to the current collector 201. Other adhesives may be utilized depending on the desired strength, as long as they can provide adhesive strength with sufficient conductivity following processing.

FIG. 3 is a flow diagram of a process for direct coating electrodes, in accordance with an example embodiment of the disclosure. This process comprises physically mixing the active material, conductive additive, and binder together, and coating it directly on a current collector. This example process comprises a direct coating process in which an anode slurry is directly coated on a copper foil using a binder such as CMC, SBR, Sodium Alginate, PAI, PAA, PI and mixtures and combinations thereof. Another example process comprising forming the active material on a substrate and then transferring to the current collector is described with respect to FIGS. 4A and 4B.

In step 301, the raw electrode active material may be mixed using a binder/resin (such as PI, PAI), solvent, and conductive carbon. For example, graphene/VGCF (1:1 by weight) may be dispersed in N-Methyl pyrrolidone (NMP) under sonication for, e.g., 1 hour followed by the addition of Super P (1:1:1 with VGCF and graphene) and additional sonication for, e.g., 45-75 minutes. Silicon powder with a desired particle size, may then be dispersed in polyamic acid resin (15% solids in NMP) at, e.g., 1000 rpm in a ball miller for a designated time, and then the conjugated carbon/NMP slurry may be added and dispersed at, e.g., 2000 rpm for, e.g., another predefined time to achieve a slurry viscosity within 2000-4000 cP and a total solid content of about 30%. The particle size and mixing times may be varied to configure the active material density and/or roughness.

In step 303, the slurry may be coated on the foil at a loading of, e.g., 3-4 mg/cm², which may undergo drying in step 305 resulting in less than 15% residual solvent content. In step 307, an optional calendering process may be utilized where a series of hard pressure rollers may be used to finish the film/substrate into a smoother and denser sheet of material.

In step 309, the active material may be pyrolyzed by heating to 500-800° C. such that carbon precursors are partially or completely converted into pyrolytic carbon. The pyrolysis step may result in an anode active material having silicon content greater than or equal to 50% by weight, where the anode has been subjected to heating at or above 400° C. Pyrolysis can be done either in roll form or after punching in step 311. If done in roll form, the punching is done after the pyrolysis process. The punched electrode may then be sandwiched with a separator and cathode with electrolyte to form a cell.

In step 313, the cell may be subjected to a formation process, comprising initial charge and discharge steps to lithiate the anode, with some residual lithium remaining.

Use of a direct coating process may have some limitations and/or challenges, however. For example, because the pyrolysis is done after the active material is coated on the collector, the pyrolysis must be performed at lower temperatures than would be done with other approaches (e.g., with lamination based processes), to avoid damaging the collector—e.g., at 500-800° C. Thus, certain measures may be needed to ensure that sufficient carbonization occurs when the pyrolysis step is performed.

Accordingly, in various implementations in accordance with the present disclosure, special slurry formulations may be devised and used to optimize performance of anodes made using direct coating processes. For example, such slurry formulations may incorporate use of carbon additives. In this regard, carbon additives that may be used in such slurry formulations are selected such that when the anode is heat-treated during the pyrolysis step, the material would partially or fully carbonize. The material may be selected based on carbonization characteristics thereof.

For example, some materials may not be suitable as it may not be fully wet because of clumping or air, particularly with the lower temperature used in direct coating processes. Thus, the selected additives used in such slurry formulations may comprise material having carbon particles with high surface energy for improving wettability of slurry. Use of such carbon additives may have additional benefits, as such material may also create features in the electrode that are beneficial for cycle life, such as porosity. Further, high surface area carbon particles also tend to increase electrical conductively at lower concentration. The selection of additives may be based on testing and experimentation, to determine the most suitable additive (or combinations thereof). Example additives that may be used may include carbon black Super-P, carbon black ECP, carbon black ECP-600JD, and graphite SLP30. FIGS. 4A and 4B illustrate various slurry formulation incorporating such additives.

In some implementations, additional measures (beyond just adjusting the slurry formulation) may be used to further enhance performance of anodes formed using direct coating. For example, in some instances, measures and/or techniques for enhancing wettability of the slurry may be used. Such measures and/or techniques may include, for example, treating the material used in the slurry (particularly the additives) to enhance hydrophilicity, such that the slurry may contain high-surface-energy carbon nanoparticles. Alternatively or additionally, material containing such high-surface-energy carbon nanoparticles (hydrophilic carbon black, polymer (e.g., polyvinyl chloride (PVC), polyacrylamide (PAM), etc.) may be added into the slurry mixture. Such carbon nanoparticles may increase wettability of anode slurry, to enhance coating onto Cu foil during a direct coating process. The wettability may further enhanced by treating the foil to which the anode slurry is applied.

FIG. 4A is a bar chart of impedance data for various anode slurry formulations, in accordance with an example embodiment of the disclosure. Shown in FIG. 4A is bar chart 400, illustrating values (determined, e.g., experimentally) for electrode impedance (in mΩ), cell impedance (in mΩ) after heating and cooling (H/C), and cell impedance (in mΩ) after formation, corresponding to ten (10) different groups of anodes. In this regard, group REF represents the reference anode group (e.g., film or lamination based anodes), with the remaining groups representing different direct-coated, silicon-dominated anodes. The groups may differ from one another based on the formulations corresponding thereto, as well as based on variations in other characteristics, such as type, length, and weight of foil used for the collector.

Details regarding different example formulations used in the different groups are shown in the table, below. In this regard, the formulation refers to the content (as percentage of weight) of the anodes after pyrolysis, including the silicon, carbon originating from additives (e.g., Super-P, ECP, ECP600JD, etc.), and carbon originating from binder (e.g., from polyamide-imide (PAI), polyacrylic acid (PAA), etc.). As noted, group 7 represents the reference anode group (formed by other methods), and as such no formulation data is provided for that group.

TABLE 1
formulations for different anode groups

| Group | Si | C/Super-P | C/ECP | C/ECP600 | C/PAI | C/PAA |
|---|---|---|---|---|---|---|
| 1 | 94% | 2% | — | — | 4% | — |
| 2 | 94% | 2% | — | — | 4% | — |
| 3 | 93.5% | — | 2% | — | 4.5% | — |
| 4 | 93.5% | — | — | 2% | 4.5% | — |
| 5 | 90% | — | — | 5% | 5% | — |
| 6 | 94% | 2% | — | — | — | 4% |
| 7 | REF | REF | REF | REF | REF | REF |
| 8 | 93.5% | — | — | 2% | 4.5% | — |
| 9 | 90% | — | — | 5% | 5% | — |
| 10 | 94% | 2% | — | — | — | 4% |

As illustrated in the bar chart 400, the anode groups (e.g., groups 3, 4, and 5) incorporating use of carbon additives with high surface area carbon (e.g., ECP that has a surface area of 800 m²/g, and ECP600JD which has a surface area of 1300-1400 m²/g) show lower impedance (and thus higher electrical conductivity). In particular, group 5 anodes show low dry impedance that is comparable to the group 7 (reference) anodes. The same trend is observed with cells made using these anodes. After formation stage, groups 3-5 with high surface area carbons show lower cell impedance than that of reference group.

FIG. 4B is a plot illustrating the cycle performance for various anode slurry formulations with different combinations of additives, in accordance with an example embodiment from the table 1. The discharge capacity is measured under 4 C charge to 4.2V and 0.5 C discharge to 3.3V (4 C(4.2V)/0.5 C(3.3V)) test conditions.

As shown in the chart in FIG. 4B, discharge capacity retention slopes are improved in the order of group 1 (2% SP)<Group 3 (2% ECP)<Group 4 and Group 8 (2% ECP600)

Although high surface area carbons show enhanced capacity retention, Si contents are varied in each formulation. Separate study was prepared with fixed Si contents at 90%

TABLE 2
formulations for different anode groups with fixed Si content

| Group | Si | C/Super-P | C/ECP | SLP | C/PAI | C/PAA |
|---|---|---|---|---|---|---|
| 11 | 90% | — | — | — | 10 | — |
| 12 | 90% | 2% | — | — | 8% | — |
| 13 | 90% | 4% | | | 6% | — |
| 14 | 90% | 6% | | | 4% | — |
| 15 | 90% | — | 2% | | 8% | — |
| 16 | 90% | | 4% | | 6% | |
| 17 | 90% | | 6% | | 4% | |
| 18 | 90% | | | 2% | 8% | |
| 19 | 90% | | | 4% | 6% | |
| 20 | 90% | | | 6% | 4% | |
| 21 | 85% | | 5% | | 10% | |

FIG. 5 is a plot illustrating discharge capacity performance for various anode slurry formulations with different combinations of additives, in accordance with an example embodiment of the disclosure. Shown in FIG. 5 is a line chart comparing the discharge capacities of anodes corresponding to two different groups: group 11 (G11, shown in black), and group 12 (G12, shown in red).

In this regard, data captured in FIG. 5 chart demonstrate effects of use of carbon additives (e.g., graphite or Super-P) in direct coating. As such, silicon content is constant in both groups (e.g., at about 94% of post-pyrolysis weight content). Group 11 uses no carbon additive—rather, the remaining content (e.g., 6% of post-pyrolysis weight content) is carbon from carbon-based polymer (e.g., polyamide-imide (PAI)) used in the slurry. Group 12 uses Super-P as carbon additive (e.g. at 2% of post-pyrolysis weight content), with the remaining content (e.g., 4%) being carbon from the carbon-based polymer (e.g., PCHC) used in the slurry.

The discharge capacity is measured under 2 C charge to 4.2V and 0.5 C discharge to 2.75V (2 C(4.2V)/0.5 C(2.75V). As shown in FIG. 5, group 12 with Super-P as carbon additive shows an improvement in the initial capacity over group 11 without a carbon additive. The discharge capacity retention of the two groups are similar initially; the anodes with Super-P as carbon additive (Group 12) shows an advantage over anodes without carbon additive (Group 11) after about 180 cycles.

FIG. 6 is a plot illustrating electrical resistance performance for various anode slurry formulations with different combinations of additives, in accordance with an example embodiment of the disclosure. The line chart shown in FIG. 6 compares the resistance of anodes corresponding to the two groups described with respect to FIG. 5. As shown in the line chart in FIG. 6, the resistance of group 12 (G12 in red) with Super-P as a carbon additive) is lower under 2 C(4.2V)/0.5 C(2.75V) test conditions.

FIG. 7 is a plot illustrating discharge capacity performance for various anode slurry formulations using different percentages of additive Super-P, in accordance with an example embodiment of the disclosure. The bar chart shown in FIG. 7 compares the discharge capacities of anodes corresponding to four different groups: group 11 (G11, shown in black), group 12 (G12, shown in red), group 13 (G13, shown in green), and group 14 (G14, shown in blue).

In this regard, data captured in the bar chart shown in FIG. 7 demonstrate effects of changing concentration of carbon additive Super-P—represented as carbon content originating from the additive in the formed anode. As such, the silicon content is maintained constant for all groups (e.g., at 90% of post-pyrolysis weight content), Further, one of the groups (e.g., group 11, (G11 shown in black) is used as a reference group—that is, representing anodes formed using slurry that includes no additive. Thus, the remaining non-silicon content of the formed anode (e.g., 10% of post-pyrolysis weight content) is presumably carbon from the carbon-based polymer used in the slurry. Group 12, (G12 shown in red) represents anodes formed using slurry with carbon additive yielding 2% carbon of post-pyrolysis weight content, with the remaining non-silicon content (e.g., 8%) being carbon from carbon-based polymer used in the slurry. Group 13, (G13 shown in green) represents anodes formed using slurry with carbon additive yielding 4% carbon of post-pyrolysis weight content, with the remaining non-silicon content (e.g., 6%) being carbon from carbon-based polymer used in the slurry. Group 14, (G14 shown in blue) represents anodes formed using slurry with carbon additive yielding 6% carbon of post-pyrolysis weight content, with the remaining non-silicon content (e.g., 4%) being carbon from carbon-based polymer used in the slurry.

As shown in the bar chart of FIG. 7, using Super-P as carbon additive at 2% improves capacity retention, but further addition resulted in worse capacity retention.

FIG. 8 is a plot illustrating discharge capacity performance for various anode slurry formulations using different percentages of additive Super-P, in accordance with an example embodiment of the disclosure. The bar chart shown in FIG. 8 compares the discharge capacities of anodes corresponding to two different groups: group 11 (G11, shown in black) and group 12 (G12, shown in red).

In this regard, data captured in the bar chart shown in FIG. 8 demonstrate effects of using carbon additive Super-P—represented as carbon content originating from the additive in formed anodes. As such, the silicon content is maintained constant for all groups (e.g., at 90% of post-pyrolysis weight content), Further, one of the groups (e.g., group 11 or G11 in FIG. 8) is used as a reference group—that is, representing anodes formed using slurry that includes no additive. Thus, the remaining non-silicon content of the formed anode (e.g., 10% of post-pyrolysis weight content) is presumably carbon from the carbon-based polymer used in the slurry. Group 12 (or G12 in FIG. 8) represents anodes formed using slurry with carbon additive yielding 2% carbon of post-pyrolysis weight content, with the remaining non-silicon content (e.g., 8%) being carbon from carbon-based polymer used in the slurry.

As shown in the chart of FIG. 8, using Super-P as carbon additive at 2% improves capacity retention.

FIG. 9 is a plot illustrating discharge capacity performance for various anode slurry formulations using different percentages of additive Super-P, in accordance with an example embodiment of the disclosure. The bar chart shown in FIG. 9 compares the discharge capacities of anodes corresponding to four different groups: group 11 (G11, shown in black), group 12 (G12, shown in red), group 13 (G13, shown in green), and group 14 (G14, shown in blue).

In this regard, data captured in the bar chart shown in FIG. 9 demonstrate effects of changing concentration of carbon additive Super-P—represented as carbon content originating from the additive in formed anode. As such, the silicon content is maintained constant for all groups (e.g., at 90% of post-pyrolysis weight content), Further, one of the groups (e.g., group 11 or G11 in FIG. 9) is used as a reference group—that is, representing anodes formed using a slurry that includes no additive. Thus, the remaining non-silicon content of the formed anode (e.g., 10% of post-pyrolysis weight content) is presumably carbon from the carbon-based polymer used in the slurry. Group 12 (or G12 in FIG. 9) represents anodes formed using a slurry with carbon additive yielding 2% carbon of post-pyrolysis weight content, with the remaining non-silicon content (e.g., 8%) being carbon from carbon-based polymer used in the slurry. Group 13 (or G13 in FIG. 9) represents anodes formed using a slurry with carbon additive yielding 4% carbon of post-pyrolysis weight content, with the remaining non-silicon content (e.g., 6%) being carbon from carbon-based polymer used in the slurry. Group 14, (or G14 in FIG. 9) represents anode formed using slurry with carbon additive yielding 6% carbon of post-pyrolysis weight content, with the remaining non-silicon content (e.g., 4%) being carbon from carbon-based polymer used in the slurry.

As shown in the bar chart of FIG. 9, using Super-P as carbon additive resulted in an improvement in capacity retention, with no apparent trend correlation between concentration and capacity retention.

FIG. 10 is a plot illustrating cycle life performance for various anode slurry formulations, in accordance with an example embodiment of the disclosure. Shown in FIG. 10 is a chart of cycle life measured under 4 C charge to 4.2V and 0.5 C discharge to 3.1V (4 C(4.2V)/0.5 C(3.1V)) test conditions. With higher contents of ECP carbon at 5% and more C/PAI content at 10% to cover the large surface area of ECP carbon, the cycle retention of group 21 (G21 in black) is as good as that of group 7 (G7 in Red), film based laminated anode which was prepared by lamination after pyrolysis at higher temperature (e.g., at 1175° C.).

An example composition for use in directly coated anodes, in accordance with the present disclosure, comprises a silicon-dominated anode active material, a carbon-based binder, and a carbon-based additive, with the composition being configured for low-temperature pyrolysis. The low-temperature pyrolysis may be conducted at <850° C.

An example method, in accordance with the present disclosure, comprises mixing a composition for use in directly coated anodes, with the composition comprising: a silicon-dominated anode active material; a carbon-based binder; and a carbon-based additive, the composition being configured for low-temperature pyrolysis. The low-temperature pyrolysis is conducted at <850° C. An anode may be formed using a direct coating process of the composition on a current collector.

In an example implementation, the anode active material yields silicon constituting up to 95% of weight of a formed anode after pyrolysis.

In an example implementation, the anode active material yields silicon constituting at least 90% of weight of a formed anode after pyrolysis.

In an example implementation, the carbon-based binder yields carbon constituting between 4% and 10% of weight of a formed anode after pyrolysis.

In an example implementation, the carbon-based additive yields carbon constituting between 2% and 6% of weight of a formed anode after pyrolysis.

In an example implementation, the carbon-based additive comprises at least one of ECP, ECP600, Super-P, and SLP.

In an example implementation, the carbon-based additive comprises carbon particles with surface area >65 m²/g.

In an example implementation, the anode active material comprises at least one of polyamide-imide (PAI) and polyacrylic acid (PAA).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein, an apparatus is “configurable” to perform a function whenever the apparatus comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A composition for use in directly coated anodes, the composition comprising:
a silicon-dominated anode active material;
a carbon-based binder; and
a carbon-based additive;
wherein:
the anode active material yields silicon constituting at least 85% but less than 95% of a weight of a formed anode after pyrolysis;
the carbon-based binder yields carbon constituting between 4% and 10% of a weight of a formed anode after pyrolysis; and
the carbon-based additive yields carbon constituting between 2% and 6% of a weight of a formed anode after pyrolysis.

2. The composition according to claim 1, wherein the composition is configured for low-temperature pyrolysis, the low-temperature pyrolysis is conducted at <850° C.

3. (canceled)

4. (canceled)

5. (canceled)

6. (canceled)

7. The composition according to claim 1, wherein the carbon-based additive comprises at least one of ECP, ECP600, Super-P, and SLP.

8. The composition according to claim 1, wherein the carbon-based additive comprises carbon particles with surface area >65 m²/g.

9. The composition according to claim 1, wherein the anode active material comprises at least one of polyamide-imide (PAI) and polyacrylic acid (PAA).

10. A method comprising:
mixing a composition for use in directly coated anodes, the composition comprising: a silicon-dominated anode active material; a carbon-based binder; and a carbon-based additive,
wherein:
the anode active material yields silicon constituting at least 85% but less than 95% of a weight of a formed anode after pyrolysis;
the carbon-based binder yields carbon constituting between 4% and 10% of weight of the formed anode after pyrolysis; and
the carbon-based additive yields carbon constituting between 2% and 6% of weight of the formed anode after pyrolysis.

11. The method according to claim 10, wherein the composition is configured for low-temperature pyrolysis, the low-temperature pyrolysis is conducted at <850° C.

12. The method according to claim 10, comprising forming an anode using a direct coating process of the composition on a current collector.

13. (canceled)

14. (canceled)

15. (canceled)

16. (canceled)

17. The method according to claim 10, wherein the carbon-based additive comprises at least one of ECP, ECP600, Super-P, and SLP.

18. The method according to claim 10, wherein the carbon-based additive comprises carbon particles with surface area >65 m²/g.

19. The method according to claim 10, wherein the anode active material comprises at least one of polyamide-imide (PAI) and polyacrylic acid (PAA).
